(19) United States
(12) Patent Application Publication
(10) Pub. No.: US 2013/0319998 A1
(43) Pub. Date: Dec. 5, 2013

(54) Sauna Infrared Heating Panel Systems and Methods

(71) Applicants: Steven John Benda, Cokato, MN (US); Tracy Ray Felder, Winsted, MN (US)

(72) Inventors: Steven John Benda, Cokato, MN (US); Tracy Ray Felder, Winsted, MN (US)

(21) Appl. No.: 13/837,087

(22) Filed: Mar. 15, 2013

Related U.S. Application Data
(60) Provisional application No. 61/689,184, filed on May 31, 2012.
(60) Provisional application No. 61/689,210, filed on May 31, 2012.

(51) Int. Cl. H05B 6/00

(52) U.S. Cl. CPC H05B 6/00
USPC 219/553; 29/611

(57) ABSTRACT

An infrared (IR) heating panel for a sauna, including a thermally and electrically insulating substrate, a power buss, at least one IR heating element electrically coupled to the power buss and supported by the substrate, at least one return element electrically coupled to the power buss and the at least one IR heating element, and a shielding layer substantially covering the at least one IR heating element. The at least one IR heating element is configured to emit IR radiation when an electrical current is passed there through, and the shielding layer is arranged such that the at least one IR heating element is disposed between the shielding layer and the substrate. The shielding layer is electrically coupled to ground and configured to harness and shunt electrical field charge emitted by the at least one IR heating element.

### RELATED APPLICATIONS

This application claims the benefit of both U.S. Provisional Application No. 61/689,184, entitled “Infrared Heating Element EF Shield via Conductive Weave Fabric Over-Lay or Conductive Printing Over-Lay,” and filed on May 31, 2012, and U.S. Provisional Application No. 61/689,210, entitled “Conductive Weave Fabric to Provide EF Shield over Infrared Heating Device” and filed on May 31, 2012, the contents each of which are hereby incorporated by reference in their respective entireties.

### FIELD

This disclosure relates generally to electric heating systems for sauna applications, and more particularly, to infrared heating panels and materials, arrangements and methods of shielding for such panels.

### BACKGROUND

Sauna systems throughout history have employed various systems and methods of heating a space to provide the therapeutic and cleansing effects of heat. As is well known, heat causes the human body to perspire and can also provide soothing and therapeutic effects to muscles and joints. Known systems for heating a sauna have included using open fires, enclosed stoves, and steam generators among others. While these systems have had varying degrees of effectiveness, each has further been found to present drawbacks. For example, systems using open fires, while providing direct open-flame heating, have been found to result in smoke-filled sauna rooms. Additionally, the heat created from such open fires is often short lived. On the other hand, wood stoves have been found to enable a more controlled heat over a greater period of time, but also shield the heat due to the enclosed nature of the stoves.

As a possible consequence of the drawbacks with prior heating systems, electrically-energized heaters have been developed and have gained popularity for their use in saunas. Some of these include electrically-resistive heaters and energized radiant heaters. To that end, some types of radiant heat systems have been designed to employ infrared (IR) heating panels to generate electromagnetic radiation within the infrared spectrum. When absorbed by the body of a sauna user, the IR radiation excites the molecules within the body to generate warming. Whereas steam or warm air is generally found to only heat the skin and tissue directly underneath (via conduction), IR radiation has been found to more deeply penetrate the body (e.g., to about 1.5 inches) to more effectively and comfortably warm the body to a sweating temperature without the use of a conductive medium.

As is known, an electromagnetic (EM) field is generated by passing electric current through a conductor. EM fields can generally be considered as including electric fields and magnetic fields interacting together. Electric fields stem from electric charges, with field intensity typically measured in Volts/meter. Magnetic fields are caused by an electric current of moving charges, with field or flux density typically measured in gauss. The term electromagnetic radiation (also EMR) is sometimes used to refer to EM fields radiating through space apart from their source.

Radiant heating systems are generally powered by conventional alternating current (AC) power sources, such as 110 volt, 60 Hz AC in the United States or 230 volt, 50 Hz AC in Europe. Such heating systems thus tend to generate some amount of low frequency (e.g., 50-60 Hz) electromagnetic radiation in addition to the desired IR radiation utilized for heating. It has been estimated that in some cases, IR sauna systems may generate low frequency EM radiation with magnetic field levels as high as 60 milligauss. In comparison, areas under high voltage transmission lines have been measured with low frequency magnetic field levels as high as 1.9 milligauss and outdoor areas in open spaces have been measured with low frequency magnetic field levels as low as 0.3 milligauss. In addition to the magnetic components of EM radiation, electric field components may also be emitted from infrared sauna systems

Concerns about high levels of low frequency radiation have led to multiple attempts at reducing the level of low frequency EM radiation in heating systems and saunas, including IR heating systems used in saunas. These include increasing the distance from the emitting source and reducing the exposure time to the radiation level. In addition, attempts have also been made to reduce the level of low frequency EM radiation through EM cancellation schemes, such as by producing multiple low frequency EM fields that tend to cancel one another.

### SUMMARY

Embodiments of the present invention relate to infrared (IR) systems for saunas, with such systems involving one or more infrared heating panels. Each panel is configured to include a substrate, and an IR heating element supported by the substrate. When energized, the heating element emits IR radiation. A return element is also supported by the substrate and generally forms a circuit with the IR heating element. One goal of the present invention is to reduce or eliminate the emission of electric fields into the sauna from such panels, in particular the IR heating element. Electric fields can be reduced or eliminated by a conductive shielding layer electrically coupled to earth ground and disposed between the source of the electric field and the area of desired field reduction.

Shielding of infrared panels is embodied herein in many forms. Some forms include the use of single- or double-layered conductive weave materials that can be used to overlay or cover the IR heating elements, while in other cases, the shielding may be printed directly onto the panel or substrate so as to positioned atop the IR heating elements. The shielding may be connected to earth ground in order to prevent the buildup of electrical charge or the flow of induced electrical currents there through.

In one embodiment, an IR heating panel for a sauna is provided. The panel comprises a thermally and electrically insulating substrate, a power buss, at least one IR heating element electrically coupled to the power buss and supported by the substrate, at least one return element electrically coupled to the power buss and the at least one IR heating element, and a shielding layer substantially covering the at least one IR heating element. The at least one IR heating element is configured to emit IR radiation when an electrical current is passed there through. The return element is further supported by the substrate and is substantially parallel with and proximate to the at least one IR heating element. The shielding layer is arranged such that the at least one IR heating element is disposed between the shielding layer and the substrate. The shielding layer is electrically coupled to ground and configured to harness and shunt electrical field charge emitted by the at least one IR heating element.

In an additional element, an IR heating panel for an sauna is provided. The panel comprises a thermally and electrically insulating substrate, a power buss, a plurality of IR heating elements electrically coupled to the power buss and supported by the substrate, a plurality of return elements each electrically coupled to the power buss and to a corresponding one of the IR heating elements, and a shielding layer substantially covering each of the IR heating elements and the power buss. The IR heating elements and return elements form a circuit with the power buss, wherein electrical power provided to the circuit causes at least the IR heating element to emit IR radiation. The shielding layer is arranged such that the IR heating elements and power buss are disposed between the shielding layer and the substrate. The shielding layer is electrically coupled to ground and configured to harness and shunt electric field charge emitted by the power buss or the IR heating elements.

In a further embodiment, a method for producing an IR heating panel for a sauna is provided. The method comprises providing a thermally and electrically insulating substrate; coupling, to the substrate, at least one IR heating element, a return element associated with the at least one IR heating element, and a power buss such that the at least one IR heating element, return element and power buss are supported by the substrate; electrically coupling the at least one IR heating element and return element to the power buss such that, as electrical power is applied to the power buss, an electrical current flows through the at least one IR heating element, causing it to emit IR radiation, and back through the return element; and applying, to the substrate, a shielding layer that is disposed between the substrate and the shielding layer and electrically coupled to ground, such that electric field charges emitted from the at least one IR heating element are harnessed and shunted by the shielding layer.

These and other aspects and features of the invention will be more fully understood and appreciated by reference to the appended drawings and the description of the preferred embodiments.

### BRIEF DESCRIPTION OF THE DRAWINGS

FIG. 1 is a cross-sectional view of a front side of an exemplary IR heating panel in accordance with certain embodiments of the invention;

FIG. 2 is an enlarged view of a portion of the cross-sectional view of FIG. 1;

FIG. 3 is an elevation view of an exemplary dual-layer EF shield with a portion of the shield pulled back for illustrative purposes in accordance with certain embodiments of the invention;

FIG. 4 is an elevation view of an exemplary single-layer EF shield in accordance with certain embodiments of the invention; and

FIG. 5 is a cross-sectional view of the panel of FIG. 2, taken at line 5-5.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives. Where applicable, like reference numbers will be used for like components, though like components need not be identical from embodiment to embodiment.

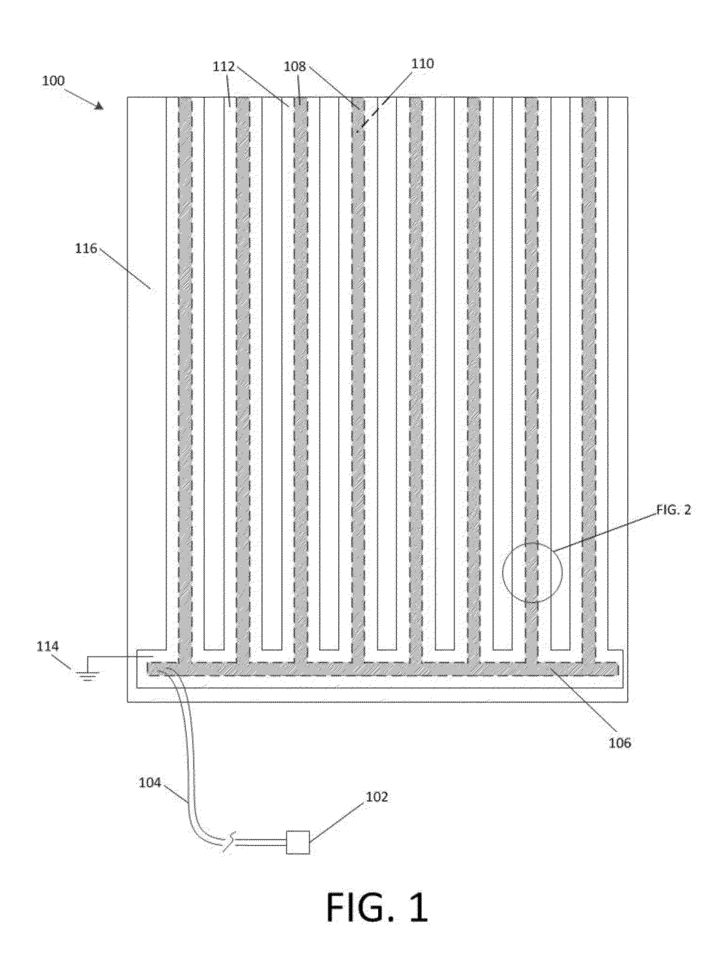

Saunas that employ electrically energized heaters generally utilize a series of individual infrared (IR) heating panels, designed to emit IR radiation into the sauna room. FIG. 1 shows a cross-sectional view of a front side of an exemplary IR heating panel 100 in accordance with certain embodiments of the invention. As shown, the panel 100 includes an insulating substrate 116. In certain embodiments, the substrate 116 can be formed of a non-flammable, electrically and thermally insulating material. One example of such material is FR-4 glass-reinforced epoxy, a material often used in printed circuit board (PCB) applications. Supported by the substrate 116 are a series of IR heating elements 108, configured to produce IR radiation when an electrical current is passed there through. In certain embodiments, the elements 108 may be encased within the substrate 116, as is the case exemplified in FIG. 1; however, the elements 108 can instead be laid atop the substrate 116. While a series of such elements 108 are shown, the invention should not be so limited. For example, the panel 100, in certain cases, could have only a single IR heating element 108, or be referred to as having at least one element 108. In certain embodiments, the IR heating elements 108 can take the form of carbon fiber circuit printings on the substrate 116, and in certain cases, can be semi-conductive; however, the invention should not be limited to such.

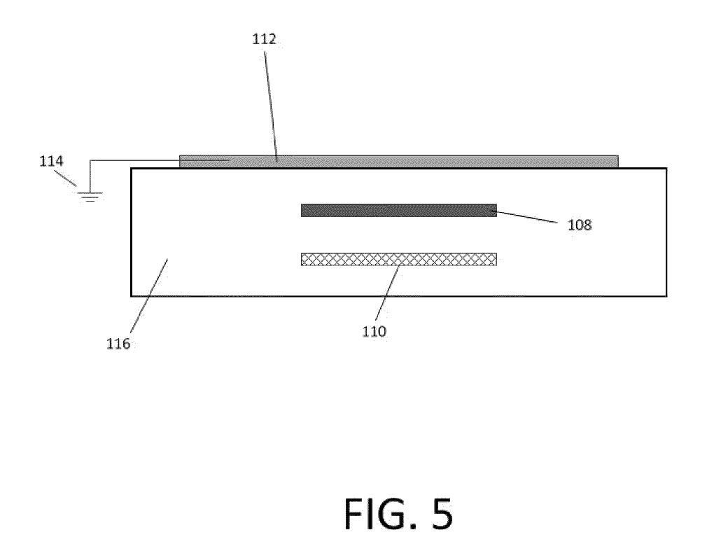

Each IR heating element 108 is connected to a power supply. In the embodiment shown in FIG. 1, each IR heating element 108 is electrically coupled to a power distribution buss 106. The buss 106, in turn, can be electrically coupled to an external power source 102 (e.g., such as a standard power outlet) via electrical power cord 104. Electrical return elements 110 associated with each IR heating element 108 can, in certain embodiments, be situated along the back side of the panel 100. This is the case exemplified in FIG. 1 wherein the return elements 110 are situated underneath the IR heating elements 108 (and thus hidden from view); however, the invention should not be limited to such arrangement. As is known, the return elements 110 (shown in FIG. 5) provide a current return path for the IR heating elements 108 back to the power buss 106. As such, a series circuit arrangement is provided involving the IR heating element 108, the return element 110, and the power buss 106.

In certain embodiments, the return elements 110 can be conductive, and in further embodiments, the IR heating elements 108 can be semi-conductive, thus providing higher electrical resistance than the return elements 110 so as to dissipate more electrical power. Alternatively, the return elements 110 may each further include an additional IR heating element, such that infrared radiation is emitted from multiple sides (e.g., front and back sides) of the panel 100, for example. In such embodiments, further shielding may additionally be utilized to more closely cover the return elements 110.

In certain embodiments, the return elements 110, are situated below yet also aligned with (e.g., running parallel to) corresponding of the IR heating elements 108, so that currents flowing through the two elements 108, 110 travel in opposite directions yet are in close proximity. Such a configuration allows the magnetic field generated from each return element 110 to generally oppose the magnetic field generated from each IR heating element 108, resulting in the fields generally negating each other. To allow for further magnetic field cancellation, the supply and return paths of the buss 106, as well as the conductors of the power cord 104 coupling the buss 106 to an external supply, may also be configured to be in close proximity to one another. In further embodiments, the cord 104 may comprise a twisted pair of conductors, reducing field emissions therefrom as current flows there through. To that end, it is to be appreciated that various configurations of the IR heating panel 100 allow for the reduction of emitted magnetic fields.

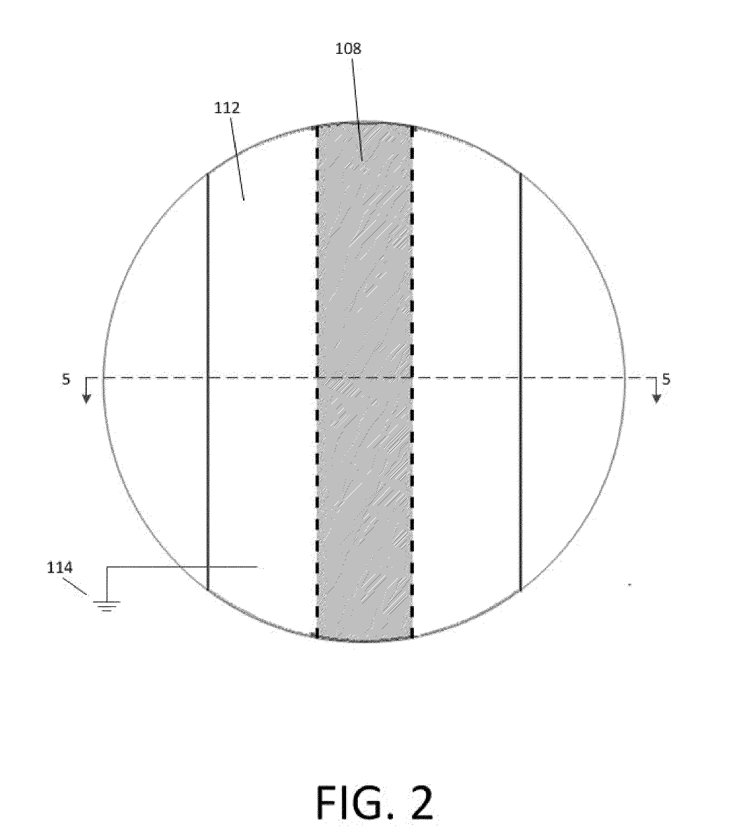

During operation, power supplied to the IR heating elements 108 corresponds to electric field (EF) generation. As exemplified in FIG. 1, electrically conducting shielding 112 is situated to overlay the IR heating elements 108 in an effort to harness the electric field. With continued reference to FIG. 1 (and FIGS. 2 and 5), in certain embodiments, the shielding 112 can be formed to cover the entire upper surface of the IR heating elements 108 (as well as that of the return elements 110), and is electrically coupled to earth ground 114 so as to conduct, or effectively shunt, any induced electric currents to ground. In certain embodiments, the shielding 112 can be formed of a metallic or otherwise conductive weave, and/or one or more other layers such as a metallic print, plate, fabric, or conductive foil or additive. The shielding 112 in use is intended to overlay the radiation emitters of the panel 100 to effectively form an EF shielding plane. Earth ground 114 is illustrated with an electrical symbol throughout the figures, but it should be appreciated that the physical electrical coupling to earth ground 114 can be provided in any suitable manner. As just one example, the shielding 112 may be electrically coupled to a conductor within power cord 104 that is coupled to earth ground (e.g., through an electrical socket).

FIG. 2 is an enlarged view of circled section of FIG. 1. In particular, FIG. 2 shows a portion of a single IR heating element 108 (overlaying the substrate 116), with shielding 112 completely overlaying the IR heating element 108 and being electrically coupled to earth ground 114. Thus, electric fields stemming outward toward the front of the panel 100 may be harnessed or captured by the shielding 112 and conducted to ground 114, minimizing a buildup of charge on the shielding 112. In certain embodiments, the shielding 112 may completely cover each IR heating element 108 in strips such as is shown in FIG. 1. Alternately, in certain embodiments, a single shielding 112 plane may be used to collectively cover each and every IR heating element 108.

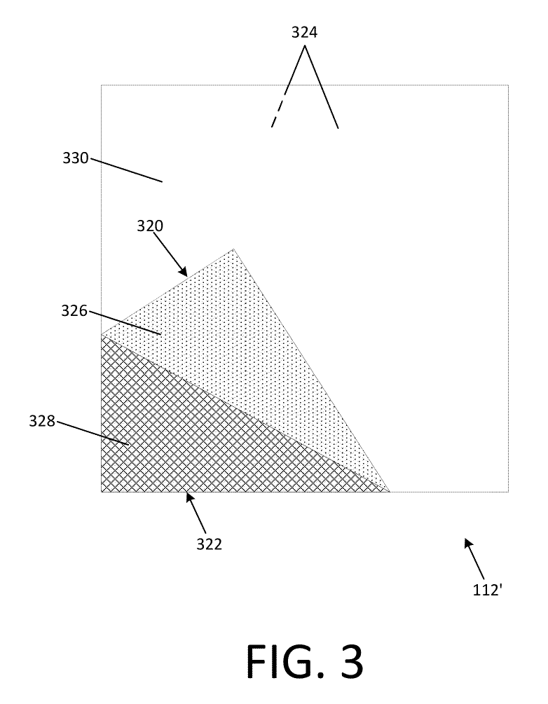

Various embodiments of shielding 112 can be implemented with an IR heating panel. FIG. 3 is a view of a dual-layer EF shield 112′ in accordance with certain embodiments of the invention. As shown, the shield 112′ includes a first layer 320 and a second layer 322, each of which is generally flat and includes black coloring on at least the outer surface 324. The surfaces 324 may be naturally black, or may be colored black using known methods and materials. With regard to the first layer 320, the inner surface comprises a black plain weave conductive fabric 326, shown by a crosshatched pattern in FIG. 3. In certain embodiments, the conductive fabric 326 is sized at least large enough to completely cover the upper surface of at least one of the IR heating elements 108 of the panel 100. In certain embodiments, a high-temperature adhesive (referenced as 328 and exemplarily shown on inner surface of the second layer 322) is applied between the first 320 and second 322 layers, and secures the two layers together in such a way so that the black surfaces 324 define opposing surfaces of the shield 112′. In certain embodiments, after the above assembly steps, the outer surfaces of the shield 112′ can be coated with a flame retardant surface coating 330. The resulting shield 112′ can in turn be configured as a multi-functional shield. In particular, the shield 112′ can be configured to harness induced electrical charge from the IR (and return) elements via the conductive fabric 326, withstand high temperatures associated with the heating panel 100 via the high temperature adhesive 328 and the flame retardant coating 330, and effectively transmit IR energy coming from the panel via the black coating on each outer side.

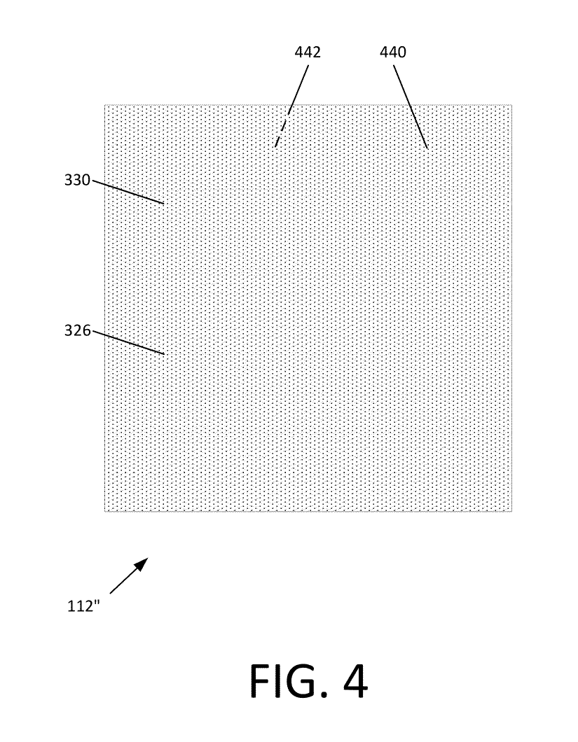

As an alternative to the dual-layer shield 112′ of FIG. 3, FIG. 4 shows a single-layer EF shield 112″ in accordance with certain embodiments of the invention. The single-layer shield 112″ has similarities to the dual-layer EF shield 112′ of FIG. 3. For example, the single-layer shield 112″ includes a conductive weave fabric 326. The single layer shield additionally includes outer surfaces (front surface 440 and back surface 442) having black coloring or covering. Alternately, in certain embodiments, the conductive weave fabric 326 can itself be black. In certain embodiments, the fabric 326 can also be coated with a flame retardant surface coating 330. Thus, the resulting shield 112″ can in turn be configured as a multi-functional shield. In particular, the shield 112″ can be configured to harness induced electrical charge from the IR (and return) elements via the conductive fabric 326, withstand high temperatures associated with the heating panel 100 via the flame retardant coating 330, and effectively transmit IR energy coming from the panel via the black coating on each outer surface 440, 442.

The conductive shielding (or shield) 112 of FIG. 1 can be constructed in multiple ways. In certain embodiments, the shielding involves a weave configuration, such as the dual-layered or single-layered shields 112′, 112″ shown in FIGS. 3 and 4, respectively. Such weaves can be coupled atop of the panel or adhered thereto so as to be maintained in a position substantially overlaying the IR heating elements 108. In certain embodiments, the weaves are positioned to entirely overlay the IR heating elements 108. Alternatively, in certain embodiments, the conductive EF shield 112 may comprise a printed layer that is situated above the IR heating elements, as further described herein with regard to FIG. 5.

FIG. 5 is a cross-sectional view of the panel of FIG. 2, taken at line 5-5 and including a printed shielding layer. The panel 100 comprises an IR heating element 108, a return element 110 shown in a double crosshatched pattern, and a conductive shielding 112 coupled to earth ground 114, all layered within an insulating substrate 116. Exemplary materials can include carbon fiber for the IR heating element 108, copper for the return element 110, and carbon fiber for the printed shielding layer 112. As described above, the substrate 116 can be formed of an FR-4 material. In certain embodiments, the insulating substrate 116 can be patterned with particular traces of conducting elements to allow current conduction along certain paths, similar to known PCB manufacturing methods. Thus, in such an embodiment, differing layers of substrate 116 can be formed, with intervening steps taking place in forming layers involving the return element 110, the IR heating element 108, and the conductive shielding 112. While not shown in FIG. 5, in cases in which the conductive shielding 112 is a printed layer, then a final substrate 116 layer is formed to overlay the shielding 112. Incorporating such known methods of PCB manufacturing in the design process of the IR heating panel enables possible lower cost and increased efficiency of production.

Continuing with FIG. 5 (and with reference to FIG. 1), during operation of the panel 100, power is provided to the distribution buss 106, so as to energize the IR heating elements 108. In a return path to the power source 102 (via the buss 106), oppositely-directed current flows back through the return element 110. The electrical energy supplied to the IR heating elements 108 results in emission of IR radiation. However, the current flowing through the elements 108 also results in the elements 108 in EF generation. In the embodiment of FIG. 5, conductive shielding 112 (e.g., printed shielding layer) is provided above the IR heating element 108 to prevent such electric fields from being emitted from the panel 100. The shielding 112 is electrically coupled to earth ground to conduct, and effectively shunt, any induced charge from the electric field. In the embodiment shown in FIG. 5, the IR heating element 108, shielding 112, and return element 110 are electrically isolated from one another by layers of the substrate material 116, such as FR-4. While the illustrated embodiment of FIG. 5 shows the shielding 112 to extend a certain width beyond the edges of the IR heating element 108, alternative embodiments of the invention may comprise the shielding 112 being entirely continuous across every IR heating element 108 of the panel 100.

In certain embodiments, the shielding 112, 112′, 112″ can be used to cover the buss 106 in addition to the IR heating and return elements 108, 110. Referring back to FIG. 1, the shielding 112 is shown as covering each IR heating element 108 and the buss 106. In some embodiments, small gaps in the shielding 112 (between the IR heating elements 108, as shown) may be necessary to allow for electrical connection between various components. However, while not shown, other embodiments can involve the shielding 112 be formed to cover all the IR heating elements 108 without gaps there between. Additionally, in certain embodiments, a continuous shielding 112 can cover an entire front side of the panel 100 atop the IR heating elements 108. Alternately, in certain embodiments, a continuous shielding 112 can cover an entire front side of the panel 100 as well as one or more of lateral and back sides of panel 100.

It should be understood that the foregoing is a description of preferred embodiments of the invention, and various changes and alterations can be made without departing from the spirit of the invention.

1. An infrared (IR) heating panel for a sauna, comprising:
a thermally and electrically insulating substrate;
a power buss;
at least one IR heating element electrically coupled to the power buss and supported by the substrate, the at least one IR heating element configured to emit IR radiation when an electrical current is passed there through;
at least one return element electrically coupled to the power buss and the at least one IR heating element, the return element being further supported by the substrate and being substantially parallel with and proximate to the at least one IR heating element; and
a shielding layer substantially covering the at least one IR heating element, the shielding layer arranged such that the at least one IR heating element is disposed between the shielding layer and the substrate, the shielding layer electrically coupled to ground and configured to harness and shunt electrical field charge emitted by the at least one IR heating element.

2. The IR heating panel of claim 1, wherein the at least one IR heating element has a higher electrical resistance than the at least one return element.

3. The IR heating panel of claim 1, wherein the at least one return element comprises a further IR heating element, whereby the panel is configured to emit IR radiation from multiple sources and via the shielding layer is configured to harness and shunt electrical field charge emitted from the multiple sources.

4. The IR heating panel of claim 3, further comprising a further shielding layer positioned between the at least one return element and the substrate so as to further harness and shunt electrical field charge emitted by the at least one IR heating element.

5. The IR heating panel of claim 1, wherein the at least one IR heating element comprises a plurality of IR heating elements, each spaced across the substrate of the panel.

6. The IR heating panel of claim 1, wherein the at least one IR heating element comprises semi-conductive carbon.

7. The IR heating panel of claim 1, wherein the shielding layer is operatively coupled to the panel.

8. The IR heating panel of claim 7, wherein the shielding layer comprises a conductive weave.

9. The IR heating panel of claim 8, wherein the conductive weave comprises a double-layered conductive weave.

10. The IR heating panel of claim 1, wherein the shielding layer is one of a stack of layers bound by the substrate.

11. The IR heating panel of claim 10, wherein the shielding layer comprises a printed layer.

12. An infrared (IR) heating panel for a sauna, the panel comprising;
a thermally and electrically insulating substrate;
a power buss;
a plurality of IR heating elements electrically coupled to the power buss and supported by the substrate;
a plurality of return elements each electrically coupled to the power buss and to a corresponding one of the IR heating elements, the IR heating elements and return elements forming a circuit with the power buss, wherein electrical power provided to the circuit causes at least the IR heating element to emit IR radiation; and
a shielding layer substantially covering each of the IR heating elements and the power buss, the shielding layer arranged such that the IR heating elements and power buss are disposed between the shielding layer and the substrate, the shielding layer electrically coupled to ground and configured to harness and shunt electric field charge emitted by the power buss or the IR heating elements.

13. The IR heating panel of claim 12 wherein the return elements are positioned underneath and aligned with the corresponding IR heating elements.

14. The IR heating panel of claim 12, wherein the shielding layer is printed onto the substrate.

15. The IR heating panel of claim 12, wherein the shielding layer comprises the same material as the IR heating element.

16. The IR heating panel of claim 15, wherein the shielding layer and the IR heating element comprise a carbon material.

17. The IR heating element of claim 12, wherein the shielding layer comprises a conductive weave material.

18. The IR heating element of claim 17, wherein the conductive weave material comprises at least one black surface.

19. A method for producing an infrared (IR) heating panel for a sauna, the method comprising:
providing a thermally and electrically insulating substrate;
coupling, to the substrate, at least one IR heating element, a return element associated with the at least one IR heating element, and a power buss such that the at least one IR heating element, return element and power buss are supported by the substrate;
electrically coupling the at least one IR heating element and return element to the power buss such that, as electrical power is applied to the power buss, an electrical current flows through the at least one IR heating element, causing it to emit IR radiation, and back through the return element; and
applying, to the substrate, a shielding layer that is disposed between the substrate and the shielding layer and electrically coupled to ground, such that electric field charges emitted from the at least one IR heating element are harnessed and shunted by the shielding layer.

20. The method of claim 19, wherein the step of applying a shielding layer comprises printing the shielding layer.

21. The method of claim 19, wherein electrically coupling the at least one IR heating element and return element to a power buss creates a series electrical circuit comprising the three.

22. The method of claim 19, wherein the at least one IR heating element has a higher electrical resistance than the return element.

23. The method of claim 19, wherein the step of applying a shielding layer comprises applying a conductive weave to the panel.

24. The method of claim 23, wherein the conductive weave is adhered to the panel.

25. The method of claim 23, wherein the conductive weave is a double-layered conductive weave and further comprises at least one black surface.
